(19) United States
(12) Patent Application Publication
(10) Pub. No.: US 2006/0205865 A1
(43) Pub. Date: Sep. 14, 2006

(54) High solids latex for dry-bright floor polish compositions

(75) Inventors: Kyung Don Kim, Westford, MA (US); Todd J. LaPlante, New Salem, MA (US); Brian T. Cartwright, Rock Hill, SC (US)

Correspondence Address: David G. Burleson, Esq.;OMNOVA Solutions, Inc., 175 Ghent Road, Fairlawn, OH, 44333-3300, US

(73) Assignee: Omnova Solutions, Inc.

(21) Appl. No.: 11/077,342

(22) Filed: Mar. 10, 2005

(51) Int. Cl. C09D 5/02

(52) U.S. Cl. 524/556; 524/127

(57) ABSTRACT

A high solids emulsion polymer composition comprising styrene, an acrylate monomer, an acidic monomer, and an anionic surfactant. The emulsion polymer composition has a solids content of at least about 43 percent by weight. The anionic surfactant may be an alkyl benzene sulfonate, such as, for example, sodium dodecyl benzene sulfonate, or may be a co-surfactant system comprising an alkyl benzene sulfonate and an aliphatic phosphate ester. The high solids emulsion polymer composition is suitable as a component in a floor polish composition, and is particularly suitable for dry bright floor polish compositions.

### BACKGROUND

The present disclosure relates, in various exemplary embodiments, to a high solids latex emulsion polymer composition. The latex emulsion polymer composition finds particular application in floor polishes and floor finishing compositions and will be described with particular reference thereto. However, it is to be appreciated that a high solids latex emulsion polymer composition in accordance with the present disclosure is also amenable to other similar applications.

Floor polish compositions often differ based on their particular application. In certain industrial or institutional settings floor polishing or finishing is often accomplished by buffing or burnishing steps after the polish is applied to the floor or surface. Such floor polish compositions must be able to withstand the burnishing step, and still provide a sufficient polish. Burnishing is typically accomplished by large buffing equipment that operate at high rotational speeds.

In many environments, however, it is desirable to apply a floor polish that does not require any additional buffing steps to achieve a sufficiently polished finish. Dry-bright compositions, as the name implies, dry to a polished finish and require little or no further buffing or burnishing steps after they are applied to a floor surface.

The solids content is an important property of dry-bright floor polish compositions. Floor polish compositions with a high solids content are desirable because such compositions require fewer applications to achieve an adequate polished finish (shine) and to provide the desired level of protection. Generally, most floor polish compositions have a solids content of 20 to 25 percent by weight of the composition. Such compositions typically require 5-6 applications or coatings to achieve adequate shine and protection. Floor polish compositions with a solids content of higher than 25%, anywhere from 25 to about 40 percent are desirable to reduce the number of applications to between about 2-4.

High solids floor polish compositions, however, have some drawbacks. A significant drawback to high solids floor polish compositions is that they exhibit high viscosities. High viscosity compositions may be difficult to apply to surfaces by conventional methods such as, for example, mopping. Thus, high solids floor polish compositions are often too viscous for standard mopping techniques.

### BRIEF DESCRIPTION

According to one embodiment of the invention, an emulsion polymer suitable for use in floor polish compositions comprises styrene in an amount from about 30 to about 50 parts per 100 parts monomer (phm); an acrylate monomer in an amount from about 40 to about 60 phm; an acidic monomer in an amount from about 5 to about 20 parts phm; a cross-linking agent in an amount of from about 0.05 to about 5 phm; and a surfactant in an amount from about 0.5 to about 2.0 phm, wherein the emulsion polymer composition has a solids content of at least about 43 percent by weight of the emulsion polymer composition.

In another embodiment, a floor polish composition comprises a component selected from the group consisting of a coalescing agent, a plasticizer, a wetting agent, a surfactant, a resin, a wax, a preservative, a biocide, a defoamer, an additive, and combinations thereof; and an emulsion polymer composition comprising styrene in an amount from about 5 to about 40 percent by weight of the emulsion polymer composition; an acrylate monomer mixture comprising methyl methacrylate, and at least one other acrylate monomer selected from the group consisting of methyl acrylate, ethyl acrylate, propyl acrylate, n-butyl acrylate, isobutyl acrylate, cyclohexyl acrylate, decyl acrylate, benzyl acrylate, methyl methacrylate, ethyl methacrylate, propyl methacrylate, n-butyl methacrylate, isobutyl methacrylate, cyclohexyl methacrylate, decyl methacrylate, benzyl methacrylate, 2-ethylhexyl methacrylate, and combinations thereof, the total acrylate monomer content being from about 10 to about 50 percent by weight of the emulsion polymer composition; an acidic monomer in an amount from about 1 to about 30 percent by weight of the emulsion polymer composition; a cross-linking agent in an amount of from about 0.025 to about 2.5 percent by weight of the emulsion polymer composition; and a surfactant comprising a material selected from the group of alkyl benzene sulfonates, aliphatic phosphate esters, and combinations thereof, wherein the emulsion polymer composition has a total solids content of at least about 43% by weight.

In still another embodiment, a floor polish composition comprises a component selected from the group consisting of a coalescing agent, a plasticizer, a wetting agent, a surfactant, a resin, a wax, a preservative, a biocide, a defoamer, an additive, and combinations thereof; and an emulsion polymer composition comprising styrene in an amount of about 30-50 phm; an acrylate monomer in an amount of about 40-60 parts phm; an acidic monomer in an amount of about 5 to about 20 phm; a cross-linking agent in an amount of about 0.1 to about 2 phm; and a surfactant selected from the group consisting of alkyl sulfate esters, polyoxyethylene alkyl sulfate esters, aliphatic phosphate esters, and combinations thereof, wherein the latex binder has a solids content of at least about 43% by weight.

In another embodiment a process for polishing a floor comprises applying a floor polish composition comprising an emulsion polymer composition to a floor. The emulsion polymer composition comprises styrene in an amount of from about 30 to about 50 phm; an acrylate monomer in an amount of from about 40 to about 60 phm; an acidic monomer in an amount from about 5 to about 20 phm; a cross-linking agent in an amount of from about 0.05 to about 5 phm; and a surfactant in an amount of from about 0.5 to 2.0 phm, the surfactant comprising a material selected from the group consisting of alkyl sulfate esters, polyoxyethylene alkyl sulfate esters, aliphatic phosphate esters, and combinations thereof. The emulsion polymer has a solids content of at least about 43 percent by weight of the emulsion polymer composition.

### DETAILED DESCRIPTION

A high solids emulsion polymer composition includes, styrene acrylic polymer latex, one or more surfactants, and has a solids content of at least 43% by weight. As used herein with respect to the emulsion polymer composition, the term “solids” refers to the non-water components of the emulsion polymer composition. As used herein with respect to the emulsion polymer composition, the term “solids content” refers to the sum of each non-water component in the emulsion polymer composition. As used herein, a high solids latex emulsion polymer composition refers to a polymer composition having a solids content of at least 43% by weight of the polymer composition.

According to one embodiment, the high solids emulsion polymer composition comprises styrene, one or more acidic monomers, one or more acrylate or acrylic monomers, a cross-linking agent, and an anionic surfactant. The emulsion polymer composition may also be referred to as a styrene-acrylic latex composition. The emulsion polymer composition can comprise a polymer, a copolymer, or terpolymer of styrene, one or more acidic monomers, and one or more acrylic or acrylate monomers. An emulsion polymer composition is, in other embodiments, a core-shell latex polymer comprising a soft core with a low glass transition temperature (T_{g}) and a hard shell with a high glass transition temperature (T_{g}). The balance of the emulsion polymer composition is water.

A high solids emulsion polymer composition in accordance with the present disclosure has a solids content of at least 43% by weight. In one embodiment, a high solids emulsion polymer composition in accordance with the present disclosure has a solids content of at least 45% by weight. In another embodiment, a high solids emulsion polymer in accordance with the present disclosure has a solids content of 43 to about 55 percent by weight. In yet another embodiment, a high solids polymer has a solids content of about 45 to about 50 percent by weight.

The styrene can be present in the emulsion polymer composition in an amount of about 30 to about 50 phm, or about 5 to about 40 percent by weight of the emulsion polymer composition. In one embodiment, styrene is present in an amount of about 10 to 25 percent by weight of the emulsion polymer composition. The emulsion polymer composition may comprise other vinyl aromatic monomers including, but not limited to, divinyl benzene and alpha-methyl styrene dimer. Such other vinyl aromatics may be introduced into the emulsion polymer composition as a cross-linking and/or chain transfer agent. These other vinyl aromatic monomers can be present in an amount of about less than 3 percent by weight of the composition.

When the emulsion polymer composition comprises methyl methacrylate, the styrene content of the styrene acrylic polymer latex is high relative to the methyl methacrylate monomer. Without being bound to any particular theory, the high styrene content, as measured by the ratio of styrene to methyl methacrylate, of the latex/emulsion polymer composition improves the gloss of the floor polish composition. In one embodiment, the styrene acrylic polymer includes methyl methacrylate and the ratio of styrene to methyl methacrylate is at least about 1:1 on a weight-to-weight basis. In another embodiment, the weight ratio of styrene to methyl methacrylate is at least about 1.5:1. In still another embodiment, the weight ratio of styrene to methyl methacrylate is in the range of from about 1:1 to about 2.5:1.

The acrylate or acrylic monomer may be an alkyl acrylate and/or alkyl methacrylate, wherein the alkyl portion comprises from 1 to about 12 carbon atoms. Examples of suitable acrylates include, but are not limited to methyl acrylate, ethyl acrylate, propyl acrylate, n-butyl acrylate, isobutyl acrylate, cyclohexyl acrylate, decyl acrylate, benzyl acrylate, and the like. Suitable alkyl methacrylates include, but are not limited to, the methacrylate homologues of the foregoing acrylates such as, for example, methyl methacrylate, ethyl methacrylate, and the like. Another example of a suitable acrylate monomer is 2-ethylhexylacrylate. The emulsion polymer composition may comprise more than one acrylate. In one embodiment, the polymer and floor polish composition includes at least methyl methacrylate and 2-ehtyhexyl acrylate. The total amount of acrylate monomer present in the emulsion polymer composition may be from about 40 to about 60 phm, or from about 10 to about 50 percent by weight of the emulsion polymer composition. In one embodiment, the total amount of acrylate monomer is from about 15 to about 30 percent by weight of the emulsion polymer composition. In another embodiment, for example, the emulsion polymer may include three or more different acrylate monomers each present in an amount of from about 3 to about 15 percent by weight of the emulsion polymer composition.

Suitable acidic monomers include, but are not limited to acrylic acid, methacrylic acid, itaconic acid, and the like. In one embodiment, the acidic monomer is methacrylic acid. The acidic monomer may be present in the emulsion polymer composition in an amount of from about 5 to about 20 phm, or from about 1 to about 30 percent by weight of the emulsion polymer composition. In one embodiment, the acidic monomer is present in an amount of about 2 to about 15 percent by weight of the polymer composition.

The polymer compositions also include a small amount of a cross-linking agent so that the various polymers are internally cross-linked. Suitable cross-linking agents are generally any compounds that cross-link the various acrylate monomers including, but not limited to, diallyl and di-acrylate compounds. Some specific examples of suitable cross-linking agents include tri-methylolpropane di-allylether, tri-methylolpropane di-acrylate, tri-methylolpropane tri-acrylate, and tri-methylolpropane tri-methacrylate and the like. A particularly suitable cross-linking agent is tri-methylolpropane tri-acrylate. A cross-linking agent may be added in an amount of from about 0.05 to about 5 parts weight per 100 parts by weight of the total monomers (phm) in the pre-emulsion solution, or from about 0.025 to about 2.5 percent by weight of the emulsion polymer composition. In one embodiment, the cross-linking agent is added in an amount of from about 0.1 to about 2 phm.

Emulsion polymer compositions in accordance with the present disclosure may also include one or more anionic surfactants. Without being bound to any particular theory, anionic surfactants may be added to the emulsion polymer composition to aid in formation of micelles in the reactor, provide stability to the polymer during emulsion polymerization and/or help reduce the viscosity of the emulsion polymer composition. Suitable anionic surfactants include, but are not limited to, alkly sulfate esters and polyoxyethylene alkyl sulfate esters. Suitable alkyl sulfate esters include alkyl benzene sulfonates. Some specific examples of suitable anionic surfactants include sodium lauryl sulfate, ammonium lauryl sulfate, sodium dodecyl benzene sulfonate, sodium alkyl naphthalene sulfonate, and sodium polyoxyethylene alkyl ether sulfonate. A particularly suitable anionic surfactant is dodecyl benzene sulfonate. It will be recognized by those skilled in the art that other anionic surfactants can also be utilized. The amount of the one or more anionic surfactants in the acqueous solution is generally small such as from 0.1 to about 10 parts and desirably from about 0.3 to about 1.5 parts by weight per 100 parts by weight of the total monomers in the pre-emulsion solution. In one embodiment, the emulsion polymer composition can include a co-surfactant system comprising two or more surfactants. A non-limiting example of a suitable co-surfactant system is a emulsion polymer composition that includes an alkyl benzene sulfonate, such as, for example, sodium dodecyl benzene sulfonate, and an aliphatic phosphate ester. Without being bound to any particular theory, an emulsion polymer composition comprising a co-surfactant system, such as, for example, sodium dodecyl benzene sulfonate and an aliphatic phosphate ester, tends to exhibit a lower viscosity as compared to a composition employing a single surfactant. However, either a single surfactant system or a co-surfactant system is suitable for use in the emulsion polymer compositions. A relatively small amount of surfactant, either as a single surfactant or co-surfactant system, is needed to provide a composition with a suitable viscosity. The surfactant may be present in the emulsion polymer composition in an amount of from about 0.5 to about 5.0 phm or from about 0.2 to about 2.0 percent by weight of the emulsion polymer composition.

The reaction mechanism of the various acrylic-type monomers and the styrene type (vinyl-substituted aromatic) monomers is via free radical polymerization and hence any such initiator can be utilized such as the various peroxides, the various azo initiators, the various perphosphates, the various persulfate initiators, and the like. Suitable peroxide initiators include, but are not limited to, t-butyl hydroperoxide, di-tert-butyl peroxide, benzoyl peroxide, benzoyl hydroperoxide, dibenzoyl peroxide, 2,4-dichlorobenzoyl peroxide, hydroxylheptyl peroxide, dicumyl peroxide, and cumene hydroperoxide. Suitable perphosphates include, but are not limited to, perphosphate and potassium perphosphate. Suitable persulfate initiators include, but are not limited to, ammonium persulfate, sodium persulfate, and potassium persulfate. The amount of the initiators are generally very small and range from, for example, about 0.1 to about 2 or 3 parts by weight, or from about 0.25 to about 1 part by weight per 100 parts by weight of the total monomers in the pre-emulsion solution.

Emulsion polymer compositions according to the present disclosure have a total solids content of at least 43% by weight of the floor polish composition. In one embodiment, an emulsion polymer composition has a solids content of 43 to about 55 percent, and, in another embodiment, has a solids content of about 45 to about 50 percent.

The emulsion polymer compositions may have a viscosity of less than 300 centipoise (cps). In one embodiment, the viscosity is from about 50 to 300 cps. In a further embodiment, the viscosity is from about 50 to about 100 cps. Viscosity may be measured at 25° C. with a suitable viscometer, such as, for example, a LVT Brookfield Viscometer.

The pH of the emulsion polymer compositions may be in the range of between about 6 to about 10. In one embodiment, the pH of the emulsion polymer composition is between about 7 and about 9.

The average particle size of the latex in the emulsion polymer compositions is not limited in any manner. The average particle size of the polymer may be less than 100 nm or it may range up to 300 nm or greater. In one embodiment, the average latex particle size is from about 50 to about 100 nm.

The emulsion polymer compositions have, in embodiments, a turbidity of from about 10 to about 60 in Nephelometric turbidity units. Turbidity is determined from the particle size of the latex, clarity of the latex solution, and the refractive index of the polymers. In the present emulsion polymer compositions, the smaller the particle size, the lower the turbidity.

Emulsion polymer compositions in accordance with the present disclosure may include other materials suitable for such compositions as is known in the art. A present emulsion polymer composition, may include, for example, a metal complex. The metal complex is generally a cross-linking agent that cross-links the polymer. The metal complex or cross-linking agent may be a polyvalent metal complex that includes a polyvalent metal component, an organic ligand component, and an alkaline component. The polyvalent metal component is a metal ion. The polyvalent metal ion is not limited to any particular metal ion, and may be, for example, beryllium, cadmium, copper, calcium, magnesium, zinc, zirconium, barium, aluminum, bismuth, antimony, lead, cobalt, iron, nickel or any other polyvalent metal that can be added to the composition as an oxide, hydroxide, or a basic, acidic or neutral salt. The alkaline component may be ammonia or an amine. The organic ligand component is not limited to any particular organic ligand. An example of a suitable organic ligand is carbonate. A non-limiting example of a suitable polyvalent metal complex is zinc ammonium carbonate.

The emulsion polymer compositions may also include a biocide or other anti-microbial agent to destroy microorganisms that may contaminate the compositions. Any biocide or anti-microbial agent suitable for use in emulsion polymer compositions may be used in the present floor polish compositions. A suitable biocide includes KATHON® LX available from Rohm and Haas.

The emulsion polymer compositions may include some residual monomers. The reason for this is that the conversion of the monomers to the polymer latex does not go to 100% completion. The residual monomer content, however, is typically small. Generally, the residual monomers are present in an amount of less than about 1000 ppm. In embodiments, the emulsion polymer composition also includes sediment in an amount of less than about 0.05 percent by weight.

Emulsion polymer compositions in accordance with the present disclosure may be made by any suitable method known in the art. The emulsion polymer compositions may be prepared by emulsion polymerization techniques known in the art including, for example, semi-continuous emulsion polymerization. Generally, the monomers are premixed to form a pre-emulsion mix. More than one pre-emulsion mix may be used in the formulation of floor polish composition according to the present exemplary embodiment. In one embodiment, a first pre-emulsion phase includes forming a solution comprising the acrylate monomers, the acidic monomers, styrene, a cross-linking agent if necessary or desired, and a second pre-emulsion phase includes forming a monomer composition different from the monomer composition of the first (pre-emulsion) phase. The initiator is separately premixed to form an aqueous solution or slurry. The initiator premix comprises water, initiator, dispersants, and emulsifying agents. The initiator is generally used in an amount of from about 0.25 to 1.0 phm. The initiator and monomer premixes are then added to an aqueous charge in a reactor. The method may include charging the initiator solution to a reaction kettle comprising water and a surfactant and then feeding the pre-emulsion mixes into the reactor.

In an exemplary embodiment, the method for preparing emulsion polymer compositions in accordance with the present disclosure includes a pre-emulsion phase that is substantially surfactant free. In conventional semi-continuous emulsion polymerization techniques, the pre-emulsion phase generally includes water, surfactants, all the different types of acrylic monomers, and a major portion of the total amount of vinyl substituted aromatic monomer (e.g., styrene). As used herein, a substantially surfactant free pre-emulsion phase of the emulsion polymerization process is substantially free of any surfactants, including anionic surfactants, cationic surfactants, nonionic surfactants, amphoteric surfactants, and the like. Without being bound to any particular theory, more uniform and smaller particle sizes are obtainable with the use of a surfactant free pre-emulsion phase. For example, in a process with a pre-emulsion phase containing surfactants, some monomers are dispersed with the micelles that are made from the surfactants, and other monomers remain as the pure monomer droplets. After charging the pre-emulsion phase (comprising surfactant(s)) to the kettle, the monomers dispersed in the micelles are not well transferred to the existing micelles in the kettle. In a process with a pre-emulsion phase substantially free of any surfactants, the pre-emulsion phase contains only pure monomer droplets. When transferred from the surfactant free pre-emulsion phase to the kettle charged with a surfactant and initiator, the monomers are quickly and uniformly transferred to the micelles in the kettle.

In one embodiment, the method for preparing the emulsion polymer composition includes: a) a preparing a pre-emulsion phase substantially free of any surfactants and comprising water, acidic monomers, acrylate monomers, and styrene; b) charging to a kettle of heated water a desired amount of one or more surfactants; c) heating the mixture of (b) to a desired temperature and charging to the kettle an appropriate amount of initiator; and d) feeding to the kettle, at a desired rate, the contents of the surfactant free pre-emulsion phase (a). In another embodiment, the pre-emulsion phase may contain at least two pre-emulsion phases: a first pre-emulsion phase comprising water, acidic monomers, acrylate monomers, and styrene monomer, and a second pre-emulsion phase comprising water and the remainder of the monomers. A first pre-emulsion phase may comprise at least about 70 percent of the monomers. In still another embodiment, the kettle charged with surfactant(s) is heated to about 80 to about 85° C., with the surfactant being charged to the kettle when the water reaches a temperature of about 65 to about 75° C. In a further embodiment, the initiator is charged to the kettle containing the surfactants when the kettle reaches a temperature of about 80 to about 85° C.

After addition of the pre-emulsion phase(s) to the kettle containing the surfactant, the batch may be allowed to exotherm to the peak temperature, then cooled to a desired temperature to add other components, such as a biocide or ligand complex. Additionally, at this point in the process a fluorinated surfactant may optionally be added to the composition. The resultant latex may be used in a typical floor polish formulation.

Copolymer latex binders in accordance with the present disclosure are generally of the two stage type and thus made in at least two stages with the first stage being as set forth hereinabove with the formation of a particle. The first stage particle is generally soft and elastic and has a T_{g} of from about 0 to about 30° C. Subsequent thereto, for example, in a second stage, no additional surfactant is utilized but generally only the remaining amount of the monomers is added to the reaction vessel. The amount of the monomers added in the second or subsequent stage (final polymerization) is generally from about 10 to about 60 percent and maybe from about 20 to about 40 percent by weight based upon the total weight of monomers, but having a different monomer composition from the first stage. Such monomers generally react with each other and the existing copolymers. In this situation, a geometric structure may be formed which is often called a core-shell copolymer, without regard to specifically what is the composition of the core versus the shell. However, it is noted that a core-shell copolymer is not always formed. Polymerization takes place at generally the same temperatures as the formation of the copolymers in the aqueous solution, that is, at a temperature generally from about 60 to about 100° C. and typically from about 80 to about 90° C.

High solids emulsion polymer compositions in accordance with the present disclosure are suitable for use as an additive in floor polish compositions, including dry-bright floor polish compositions. The emulsion polymer compositions in accordance with the present disclosure may be used “as is” in the high solids form in the polish formulation, or may be diluted to a lower solids content as desired depending upon the application requirements. In one embodiment, the emulsion polymer composition is utilized in the undiluted, high solids form.

The composition of the floor polish composition is not critical, and generally may include any components suitable for forming a floor polish composition. Examples of suitable components for a floor polish composition include, but are not limited to, coalescing agents, plasticizers, wetting agents or surfactants, resin, wax, preservatives and/or biocides, defoamers, additives and combinations thereof.

In one embodiment, a floor polish may comprise from about 30 to about 50 percent by weight of a present high solids emulsion polymer composition. In another embodiment, a floor polish composition comprises about 30 to about 40 percent by weight of a present emulsion polymer composition.

The present floor polish compositions may also include other ingredients including, for example, one or more fugitive plasticizers or coalescing agents and/or non-fugitive plasticizers. Coalescing agents and plasticizers may contribute to the dry-bright property of the polish. As used herein, the term “fugitive” refers to a material that evaporates or escapes the coating during or after film formation. Non-limiting examples of suitable fugitive coalescing agents include monohydric and polyhydric alcohols, monoalkyl and dialkyl ethers or glycols, diglycols, ether alcohols, and polyglycols. Examples of such materials include but are not limited to diethylene glycol, C₁₋₆ mono- or dialkyl ether, diethylene glycol ethyl ether, diethylene glycol butyl ether, dipropylene glycol methyl ether, tripropylene glycol ethyl ether, propylene glycol ethyl ether, glycol ether, triethylene glycol ethyl ether, etc., TEXANOL® (esterisobutyrate), benzyl alcohol, 3-methoxybutanol-1, monomethyl, monoethyl and monobutyl ethers of diethylene glycol, triethylene glycol, dipropylene glycol, tripropylene glycol, benzyl alcohol, isophorone, and methoxybutanol.

Examples of suitable non-fugitive plasticizers include but are not limited to tributoxyethyl phosphate, 2,2,4-trimethyl-1,3 pentanediol diisobutyrate, dibutyl phthalate, dioctyl phthalate, caprolactam, polypropylene glycol adipate benzoate, diethylene glycol dibenzoate, dibenzyl sebacate, acidal tributylcitrate and butyl phthalate-butyl glycolate.

Floor polish compositions according to the disclosure may also include wetting agents or surfactants, such as, for example, nonionic surfactants, that may contribute to the high dry-bright property of the compositions. Suitable surfactants include fluorinated surfactants such as those described in U.S. Pat. No. 6,660,828, U.S. Patent Application Publication No. 2004/0048957, and WO 02/092660, the disclosures of which are incorporated herein by reference. Examples of suitable surfactants include, but are not limited to, PolyFox® surfactants available from Omnova Solutions, Inc.

A non-limiting example of a conventional 20% solids floor polish composition is illustrated below in Table 1.

TABLE 1
CONVENTIONAL 20% SOLIDS FLOOR
POLISH FORMULATION CONTAINS:

| RAW MATERIAL | GRAMS |
|---|---|
| Water | 20-40 |
| Coalescing Agent (glycol ether) | 3-7 |
| Plasticizer | 2-3 |
| Fluorosurfactant/Wetting Agent | 0.10-0.20 |
| Mix for 30-45 minutes | |
| Polymer @ 38% | 24-50 |
| Resin | 0-5 |
| Mix for 30-45 minutes | |
| Wax | 2-6 |
| Preservative/Biocide | 0.02-0.10 |
| Defoamer | 0.01-0.02 |
| Additives | <5 |
| Mix for 15 minutes | |
| TOTAL | 100 gms |

Floor polish compositions may be formed by any suitable method for forming such compositions. For example, a floor polish composition is made by mixing the various components together under ambient conditions.

Floor polish compositions comprising a present high solids emulsion polymer composition can be applied to surfaces in a conventional fashion. In an embodiment, the composition is applied as follows. The floor is cleaned with a commercially available hard surface stripper-cleaner. After a thorough rinsing, the floor is allowed to dry. Next, a floor polish composition comprising a high solids emulsion polymer composition according to the present disclosure is applied by a suitable mopping swabbing or dipping procedure. The film is allowed to dry. Additional coats of the floor polish composition may be applied as needed to obtain maximum scuff resistance and durability.

High solids emulsion polymer compositions and floor polish compositions comprising such emulsion polymer compositions are further described with reference to the following examples. The examples are for purposes of illustration and are not intended to be limiting in any manner.

### EXAMPLES

### Example I

### Emulsion Polymer Compositions

A first high solids emulsion polymer composition (Sample 1) was prepared as follows. A (first) pre-emulsion monomer mixture was prepared comprising methacrylic acid, butylacrylate, 2-ethylhexyl acrylate, methyl methacrylate, styrene cross-linking agent, and deionized water. A kettle was filled with deionized water and heated to about 80 to 85° C. When the temperature was between 65 and 75° C., surfactants were charged to the kettle. An initiator solution was prepared and charged to the kettle when the temperature of the kettle containing surfactants reached about 80 to 85° C. After waiting several minutes, the (first) pre-emulsion monomer mix was added to the kettle over a period of more than about 2 hours while the temperature of the kettle/reactor was maintained at about 85° C. Following the feed of the first pre-emulsion mix, a second pre-emulsion mix comprising the remaining monomers was fed into the kettle. The batch was allowed to exotherm to the peak temperature and held there for 60 minutes. The batch was then cooled down for chase treatment. After that, zinc ammonium bicarbonate and biozide were added at room temperature.

A second high solids emulsion polymer composition (Sample 2) was prepared in essentially the same manner as Sample 1 except that an aliphatic phosphate ester surfactant was added to the kettle along with a sodium dodecyl benzene sulfonate.

The above method, yielded the following emulsion polymer compositions set forth in Table 2. The values are in percent by weight of the polymer composition.

TABLE 2

| | Sample | Sample | Sample | Sample |
|---|---|---|---|---|
| Ingredients | 1 | 2 | 3 | 4 |
| Butyl Acrylate | 5.16 | 5.15 | 5.16 | 5.15 |
| 2-Ethylhexyl Acrylate | 4.41 | 4.41 | 4.41 | 4.41 |
| Styrene | 19.83 | 19.82 | 19.00 | 18.99 |
| Methyl Methacrylate | 10.62 | 10.61 | 10.12 | 10.11 |
| Methacrylic Acid | 4.08 | 4.08 | 4.90 | 4.90 |
| Ammonium Persulfate | 0.26 | 0.26 | 0.26 | 0.26 |
| Sodium Dodecyl Benzene | 0.28 | 0.11 | 0.28 | 0.11 |
| Sulfonate | | | | |
| Aliphatic Phosphate Ester | | 0.99 | | 0.99 |
| Zinc Ammonium Carbonate | 2.13 | 2.13 | 2.56 | 2.56 |
| Trimethylol Propane | | | 0.08 | 0.08 |
| Triacrylate | | | | |
| TBHP | 0.03 | 0.03 | 0.03 | 0.03 |
| Kathon LX | 0.04 | 0.04 | 0.04 | 0.04 |
| Water | 53.16 | 52.37 | 53.16 | 52.37 |
| Total | 100.00 | 100.00 | 100.00 | 100.00 |

Table 3 shows the physical properties of the emulsion polymer compositions of Samples 1 and 2:

TABLE 3

| Property | Sample 1 | Sample 2 | Sample 3 | Sample 4 |
|---|---|---|---|---|
| Solids (%) | 44.5-45.5 | 44.5-45.5 | 44.5-45.5 | 44.5-45.5 |
| pH | 7.5-8.5 | 7.5-8.5 | 7.5-8.5 | 7.5-8.5 |
| Viscosity (cps) | 100-200 | 50-100 | 100-200 | 50-100 |
| Particle Size (nm) | 60-70 | 60-70 | 60-70 | 60-70 |
| Turbidity | 10-60 | 10-60 | 10-60 | 10-60 |
| Zn Content (%) | 0.25-0.3 | 0.25-0.3 | 0.27-0.32 | 0.27-0.32 |

### Example II

### Floor Polish Compositions

Floor polish compositions were separately prepared with the emulsion polymer of Sample 1. A control floor polish composition was prepared with a comparative polymer. The comparative polymer (Comparative Emulsion Polymer) is a styrene-acrylic based polymer having a solids content of about 37.5 to 38.5 wt. %. The floor polish compositions are set forth in Table 4.

TABLE 4

| | | Floor Polish | Floor Polish |
|---|---|---|---|
| | Control Floor | Composition | Composition |
| | Polish | 1A | 1B |
| Water | 48.55% | 55.50% | 55.95% |
| Diethylene Glycol | 2.92% | | |
| Monoethyl Ether | | | |
| (Carbitol LG) | | | |
| Dipropylene | | 2.25% | 2.25% |
| Glycol Monomethyl | | | |
| Ether (DPM) | | | |
| EEH | | 0.25% | |
| PPH | | | 0.08% |
| TEXANOL ® | | 0.42% | 0.42% |
| Tributoxyethyl | 2.84% | 2.40% | 2.40% |
| Phosphate (KP-140) | | | |
| Wacker SE-21 | 0.01% | 0.01% | 0.01% |
| Proxel GXL | 0.09% | 0.09% | 0.09% |
| Comparative | 44.00% | | |
| Emulsion Polymer | | | |
| Emulsion Polymer | | 37.49% | 37.21% |
| Sample 1 | | | |
| AC-325 Nonionic Wax | 1.54% | 1.54% | 1.54% |
| TOTAL: | 100.00% | 100.00% | 100.00% |

The compositions had a solids content of 20%. The term “solids content” as used with respect to a floor polish composition refers to the total solid, as a percentage by weight of the floor finishing composition. The term “solids” as used with respect to a floor polish composition refers to the amount of non-liquid, insoluable, or non-volatile components in the floor polish composition, including, but not limited to, polymer components, resin portion, plasticizer, surfactant(s) and the like.

Floor polish compositions 1A and 1B included dipropylene glycol monomethyl ether, TEXANOL®, and either EEH or PPH to further enhance initial and overnight gloss as well as low and high temperature film formation performance of the emulsion polymers of Sample 1 without sacrifice to other critical performance application properties.

The above floor polishes were tested using several application tests conventionally used in the floor polish industry. The floor polish compositions were tested in the following manner:

1) The polish was applied to a test tile using ASTM D1436 method B.

2) Gloss was measured and recorded in accordance with ASTM D1455. Four readings are taken per ½ tile. The average value was reported.

3) Spot and Stain was measured by ASTM D1793, dynamic test.

4) Leveling was tested by using Japanese Industrial Standard K3920 X.

5) Black Heel Mark (BHM) and scuff resistance were measured by Chemical Specialty Manufacturers Association Bulletin No. 9-73 comparatively using the Snell Capsule test on white OVCT (Official Vinyl Composition Tile available through Consumer Specialties Product Association). BHM is a real deposition of rubber heel onto or into the coating, while a scuff mark comes from physical displacement of the coating that resulted in the gloss reduction of an area.

6) BHM removability was measured by taking tiles from the BHM test and rubbing them with a green felt to remove marks from the tile. The tiles were then rated comparatively.

7) Wet Removability was measured by placing 4 mL of ready to use neutral detergent (commercially available material) on a 2″×2″ gauze pad and scrubbing lightly to remove marks. Tiles were visually evaluated after the tile was dried.

8) Scuff Resistance was measured comparatively using the Snell Capsule test on black OVCT.

9) Scuff Removability was measured by taking tiles from the Scuff Resistance Test and rubbing them with a green felt to remove and repair scuff marks. The tiles were then rated comparatively.

10) Wet abrasion was comparatively measured in accordance with ASTM D3207 with only water and no detergent solution. Two finishes were applied to the same tile for evaluation.

The tests used to evaluate the control floor polish and the floor polish that includes polymer emulsion compositions in accordance with the present disclosure and the results of the tests are set forth in Table 5.

TABLE 5

Result

| | Control | Floor Polish |
|---|---|---|
| | Floor Polish | Compositions |
| Application Test | Composition | 1A and 1B |
| 20° Gloss (4 coats, overnight) | 34.8 | 38.3-41.0 |
| 60° Gloss (4 coats, overnight) | 75.1 | 77.2-80.0 |
| Black Heel Mark Resistance | Good | Good |
| Black Heel Mark | Good | Good |
| Removability (dry) | | |
| Black Heel Mark | Good | Good |
| Removability (wet) | | |
| Scuff Resistance | Good | Good |
| Scuff Repairability | Good | Good |
| Water Spot & Stain Resistance | Good | Good |
| IPA Spot Resistance | Good | Better |
| COF (Coefficient of Friction) | Pass | Pass |
| Burnishability (electric) | Poor | Good |
| Burnishability (propane) | Poor | Fair |
| Low Temp Film Formation | Poor | Good |
| (50° F., 50% R.H.) | | |
| High Temp Film Formation | Good | Good |
| (80°+ F., 70%+ R.H.) | | |

As shown in Table 5, floor polish compositions that include a high solids emulsion polymer composition in accordance with the disclosure perform as well as or, in several instances, better than the control floor polish composition using the comparative emulsion polymer with a lower solids content. The floor polish compositions prepared with the high solids emulsion polymer composition of Sample 1 had a 20° gloss value of about 4 to about 7 gloss units higher than the gloss value of the control floor finishing composition and a 60° gloss of about 2 to about 5 gloss units higher than the control floor polish composition. A 10% improvement in gloss, which translates into an increase of about 3 gloss units, is detectable by the human eye.

The exemplary embodiment has been described with reference to various specific embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An emulsion polymer composition for use in floor polish compositions, the emulsion polymer composition comprising:
styrene in an amount of from about 30 to about 50 phm;
an acrylate monomer in an amount of from about 40 to about 60 phm;
an acidic monomer in an amount of from about 5 to about 20 phm;
a cross-linking agent in an amount of from about 0.05 to about 5 phm; and
a surfactant in an amount of from about 0.5 to about 2.0 phm,
wherein the emulsion polymer composition has a solids content of at least about 43 percent by weight of the emulsion polymer composition.

2. The emulsion polymer composition according to claim 1, having a solids content of about 43 to about 55 percent by weight of the emulsion polymer composition.

3. The emulsion polymer according to claim 1, wherein the acrylate monomer is selected from the group consisting of methyl acrylate, ethyl acrylate, propyl acrylate, n-butyl acrylate, isobutyl acrylate, cyclohexyl acrylate, decyl acrylate, benzyl acrylate, methyl methacrylate, ethyl methacrylate, propyl methacrylate, n-butyl methacrylate, isobutyl methacrylate, cyclohexyl methacrylate, decyl methacrylate, benzyl methacrylate, 2-ethylhexyl methacrylate, and combinations thereof.

4. The emulsion polymer according to claim 1, wherein the acidic monomer is selected from the group consisting of acrylic acid, methacrylate acid, itaconic acid, and combinations thereof.

5. The emulsion polymer according to claim 1, wherein the cross-linking agent is selected from the group consisting of tri-methylolpropane di-allylether, tri-methylolpropane di-acrylate, tri-methylolpropane tri-acrylate, and tri-methylolpropane tri-methacrylate.

6. The emulsion polymer composition according to claim 1, wherein the surfactant is selected from the group consisting of alkyl sulfate esters, polyoxyethylene alkyl sulfate esters, aliphatic phosphate esters, and combinations thereof.

7. The emulsion polymer according to claim 1, wherein the emulsion polymer composition has a viscosity of from about 50 to about 300 cps.

8. A floor polish composition comprising:
a component selected from the group consisting of a coalescing agent, a plasticizer, a wetting agent, a surfactant, a resin, a wax, a preservative, a biocide, a defoamer, an additive, and combinations thereof; and
an emulsion polymer composition comprising:
styrene in an amount of about 5 to about 40 percent by weight of the emulsion polymer composition;
an acrylate monomer mixture comprising methyl methacrylate, and at least one other acrylate monomer selected from the group consisting of methyl acrylate, ethyl acrylate, propyl acrylate, n-butyl acrylate, isobutyl acrylate, cyclohexyl acrylate, decyl acrylate, benzyl acrylate, methyl methacrylate, ethyl methacrylate, propyl methacrylate, n-butyl methacrylate, isobutyl methacrylate, cyclohexyl methacrylate, decyl methacrylate, benzyl methacrylate, 2-ethylhexyl methacrylate, and combinations thereof, the total acrylate monomer content being about 10 to about 50 percent by weight of the emulsion polymer composition;
an acidic monomer in an amount of about 1 to about 30 percent by weight of the emulsion polymer composition;
a cross-linking agent in an amount of about 0.025 to about 2.5 percent by weight of the emulsion polymer composition; and
a surfactant comprising a material selected from the group of alkyl benzene sulfonates, aliphatic phosphate esters, and combinations thereof,
wherein the emulsion polymer composition has a total solid content of at least about 43 percent by weight.

9. The floor polish composition according to claim 8, wherein the ratio of styrene to methyl methacrylate is from about 1:1 to about 2.5:1.

10. The floor polish composition according to claim 8, wherein the surfactant comprises both an alkyl benzene sulfonate and an aliphatic phosphate ester.

11. The floor polish composition according to claim 10, wherein the surfactant comprises sodium dodecyl benzene sulfonate.

12. The floor polish composition according to claim 11, wherein the emulsion polymer composition has a viscosity of about 50 to about 300 cps.

13. The floor polish composition according to claim 8, wherein the total solids content is about 43 to about 55 percent by weight of the polymer composition.

14. A floor polish composition comprising:
a component selected from the group consisting of a coalescing agent, a plasticizer, a wetting agent, a surfactant, a resin, a wax, a preservative, a biocide, a defoamer, an additive, and combinations thereof; and
an emulsion polymer composition comprising:
styrene in an amount of about 30 to about 50 phm;
an acrylate monomer in an amount of about 40 to about 60 phm;
an acidic monomer in an amount of about 5 to about 20 phm;
a cross-linking agent in an amount of about 0.1 to about 2 phm; and
a surfactant selected from the group consisting of alkyl sulfate esters, polyoxyethylene alkyl sulfate esters, aliphatic phosphate esters, and combinations thereof,
wherein the emulsion polymer composition has a solids content of at least about 43 percent by weight.

15. The floor polish composition according to claim 14, wherein the acrylate monomer is selected from the group consisting of methyl acrylate, ethyl acrylate, propyl acrylate, n-butyl acrylate, isobutyl acrylate, cyclohexyl acrylate, decyl acrylate, benzyl acrylate, methyl methacrylate, ethyl methacrylate, propyl methacrylate, n-butyl methacrylate, isobutyl methacrylate, cyclohexyl methacrylate, decyl methacrylate, benzyl methacrylate, 2-ethylhexyl methacrylate, and combinations thereof.

16. The floor polish composition according to claim 14, wherein the acrylate monomer comprises methyl methacrylate and at least one other acrylate monomer.

17. The floor polish composition according to claim 16, wherein the ratio of styrene to methyl methacrylate is from about 1:1 to about 2.5:1.

18. The floor polish composition of claim 14, wherein the emulsion polymer composition has a solids content of 43 to 55 percent.

19. The floor polish composition of claim 14, wherein the floor polish composition has a viscosity of 300 cps or less.

20. A process for polishing a floor, the process comprising:
applying a floor polish composition comprising an emulsion polymer composition to a floor, the emulsion polymer composition comprising:
styrene in an amount of from about 30 to about 50 phm;
an acrylate monomer in an amount of from about 40 to about 60 phm;
an acidic monomer in an amount of from about 5 to about 20 phm;
a cross-linking agent in an amount of from about 0.05 to about 5 phm; and
a surfactant in an amount of from about 0.5 to about 2.0 phm, the surfactant comprising a material selected from the group consisting of alkyl sulfate esters, polyoxyethylene alkyl sulfate esters, aliphatic phosphate esters, and combinations thereof,
wherein the emulsion polymer has a solids content of at least about 43 percent by weight of the emulsion polymer composition.
